(19) United States
(12) Patent Application Publication
(10) Pub. No.: US 2008/0125681 A1
(43) Pub. Date: May 29, 2008

(54) Massaging machine

(76) Inventor: Jianhong Zhong, Dongguan City (CN)

Correspondence Address: REED SMITH LLP, Suite 1400, Falls Church, VA, 22042, US

(21) Appl. No.: 11/812,772

(22) Filed: Jun. 21, 2007

(30) Foreign Application Priority Data
Nov. 29, 2006 (CN) 200620148179.6

(51) Int. Cl. A61H 15/00

(52) U.S. Cl. 601/99; 601/100; 601/101; 601/102; 601/116

(57) ABSTRACT

The present invention relates to a massaging machine that incorporates a motor, a main body having a top carriage, a bottom carriage and a massage driving assembly and a traveling driving assembly provided between the top carriage and the bottom carriage, and a massage head assembly having at least a massage head, a massage assembly and a massage head driving assembly. The massaging machine drives through engagement among a worm and a worm wheel, the massage driving assembly, gears and a gear rack, and a planet gear and a sun gear. The massage heads can make four types of movement simultaneously to achieve continuous variations among different massage positions within a relatively large area of a human body, while at the same time continuously varying the massaging forces applied to the human body. The present invention can also continuously massage a fixed portion of a human body. The present invention is easy to assemble and carry with its simple structure.

### BACKGROUND OF THE INVENTION

1. Field of the Invention

The present invention relates to a massaging machine, and more particularly, to a massaging machine that provides various types of movements to create multiple massaging effects to a human body.

2. Description of the Related Art

Generally, existing massaging machines only provide a periodical vibration or kneading massaging effects to certain portions of a human body through massage heads mounted on the massaging machines. However, this type of massaging machines usually only affects an unchanged portion of the human body and the massaging movement also remains unchanged. The drawbacks of the existing massaging machines are that they cannot perform massage movements to different conformations of the human body and cannot apply a massage to a larger area of a certain portion on the human body.

Chinese utility model No. 02250262.9 discloses a massaging machine having massage heads which can make three different types of massaging movements through a driving assembly and at least a pairs of massage heads at different heights to each other and engagement between gears and gear racks so that the massaging machine can simulate human hands with varied degrees of movement forces and continuously changed movement positions in a relatively large area on a human body. However, three different movements are still considered to be not enough and more movements are desirable in order to better imitate the movement of human hands.

### SUMMARY OF THE INVENTION

It is an object of the present invention to overcome the drawbacks of the existing massaging machines and to provide a massaging machine having massage heads which can make four different types of movements with continuously varying forces and positions of the massage movements at the same time.

The above object of the present invention is achieved by the following technical solutions.

The massaging machine according to the present invention comprises a motor, a main body and a massage head assembly. The main body comprises a top carriage, a bottom carriage, and a massage driving assembly and a traveling driving assembly provided between the top carriage and the bottom carriage. The massage head assembly comprises at least a massage head, a massage assembly and a massage head driving assembly fixed to the main body.

The object of the present invention is further achieved by the following technical solutions:

The massaging machine according to the present invention in which the massage driving assembly comprises a worm, a duplex worm wheels, a middle gear, a gear shaft, a gear wheel and a pinion. The worm is fixed to the driving shaft of the motor and the duplex worm wheels engage with the worm. The gear face of the duplex worm wheels engages with the middle gear and the middle gear in turn engages with the gear wheel. The gear wheel and the pinion are fixed to the gear shaft.

The traveling driving assembly comprises a duplex gear, a traveling duplex gear and a gear rack. The duplex gear engages with the traveling duplex gear which in turn engages with the gear rack. The pinion engages with the gear face of the duplex gear having a larger outer diameter.

The massage head driving assembly comprises a planet gear, a planet gear shaft, and a sun gear. The planet gear is mounted on the planet gear shaft which is fixed to a massage head support. The sun gear engages with the planet gear.

The massage assembly comprises a massage head support and a rotatable support. The massage heads and the massage head support are rotatably connected to the rotatable support via the planet gear shaft.

The massage heads are in a mushroom like shape and are mounted in pairs at different heights to each other on the two sides of the massage head support with respective to its center bore.

The massaging machine according to the present invention has the following advantages:
i. The massage heads can make four different types of massaging movements and achieve a variety of massage positions within a large area of a human body with varied forces to the human body at the same time with the help of the engagements among the worm and a worm wheel, the massage driving assembly, the gears and the gear rack, and the planet gear and a sun gear.
ii. The massage positions and types of massage can be adjusted and controlled as desired in order to achieve comfortable, soft and multi-position massage effects.
iii. The massage machine according to the present invention is easy to assemble and to carry with its simple structure.

### BRIEF DESCRIPTION OF THE DRAWINGS

The above, and other objects, features and advantages of the present invention will be made apparent from the following description of the preferred embodiments, given as non-limiting examples, with reference to the accompanying drawings in which:

FIG. 1 is a perspective view of the massaging machine according to an embodiment of the present invention;

FIG. 2 is an exploded view of the massaging machine according to an embodiment of the present invention; and

FIG. 3 is a plane view of the massaging machine according to an embodiment of the present invention, wherein the various elements and components of the present invention are referenced as follows:

| | |
|---|---|
| 1 | main body |
| 2 | massage head assembly |
| 11 | top carriage |
| 12 | bottom carriage |
| 13 | motor |
| 14 | massage driving assembly |
| 15 | travel driving assembly |
| 16 | fix screw |
| 21, 21′ | a pair of massage head |
| 22 | massage assembly |
| 23 | massage head driving assembly |
| 141 | worm |
| 142 | duplex worm wheel |
| 142′ | duplex worm wheel |
| 143 | middle gear |
| 144 | gear shaft |
| 145 | gear wheel |
| 146 | pinion |
| 147 | screw |
| 151 | duplex gear |
| 152 | traveling duplex gear |
| 153 | gear rack |
| 221 | massage head support |
| 222 | rotatable support |
| 231 | planet gear |
| 232 | planet gear shaft |
| 233 | sun gear |
| 2211 | center bore |
| 2212 | center bore |
| 2221 | center bore |

### DETAILED DESCRIPTION OF THE PREFERRED EMBODIMENTS

A detailed description of an embodiment of the present invention shown in the drawings is discussed below.

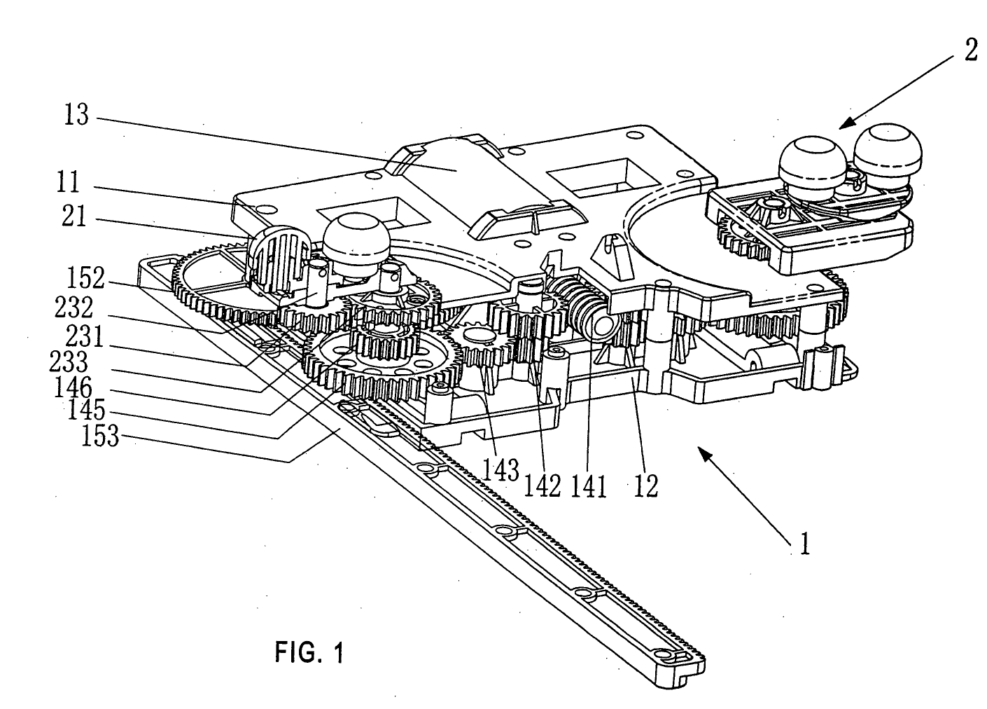

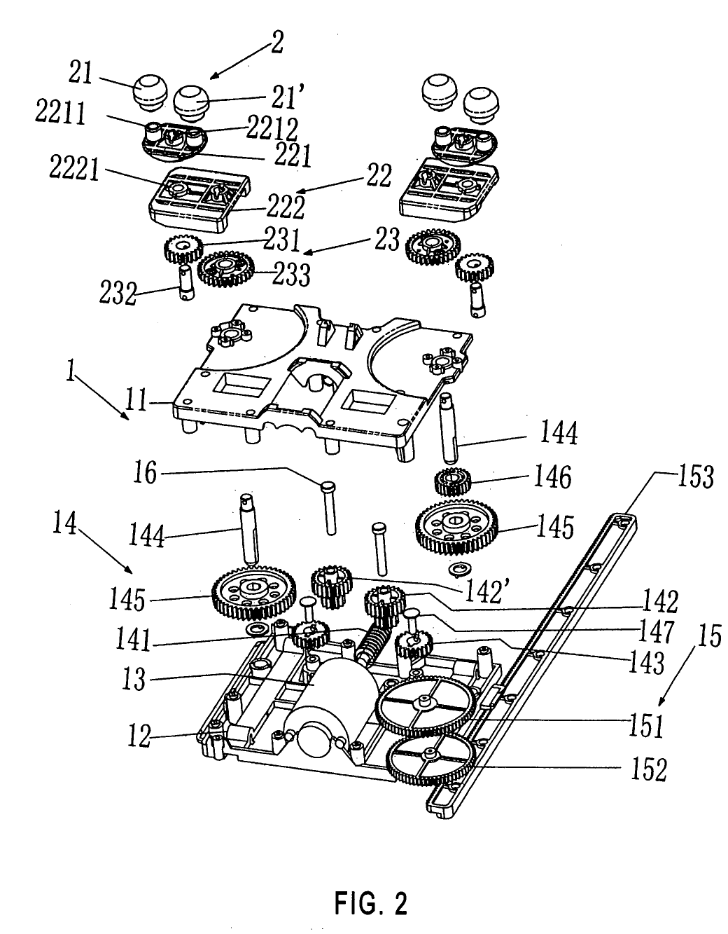

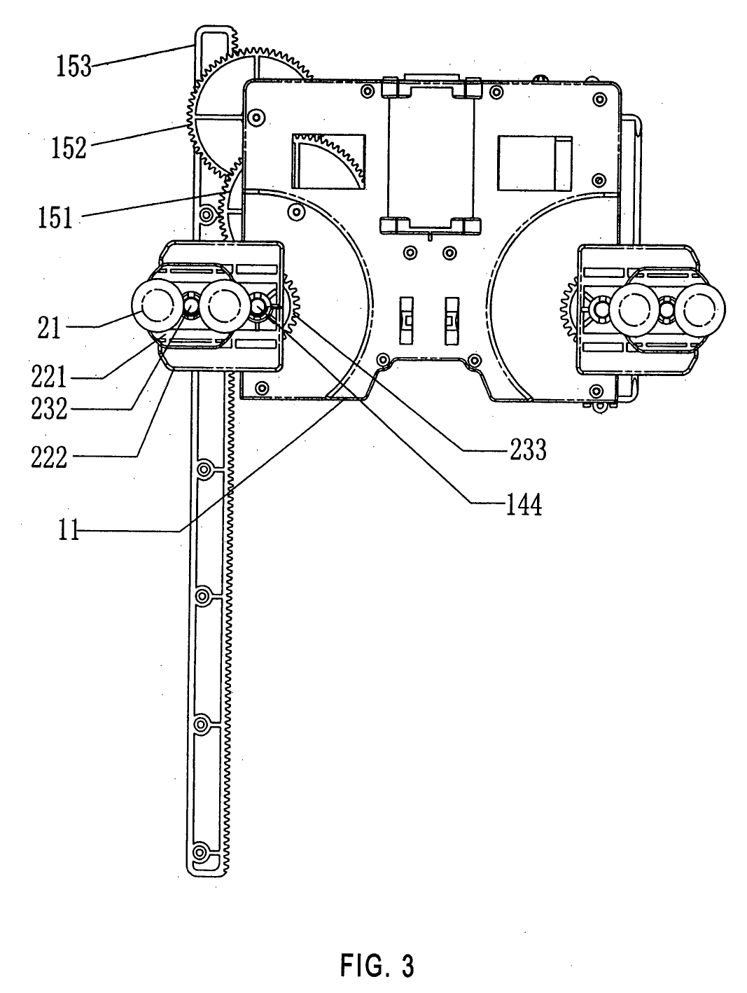

As shown in FIG. 1-FIG. 3, the massaging machine according to an embodiment of the present invention comprises at least a main body 1 and a massage head assembly 2. The main body 1 comprises a top carriage 11, a bottom carriage 12 and a motor 13, a massage driving assembly 14, and a travel driving assembly 15 and fix screws 16 set between the top carriage 11 and the bottom carriage 12. The massage driving assembly 14 comprises a worm 141, duplex worm wheels 142, 142′, a middle gear 143, a gear shaft 144, a gear wheel 145 and a pinion 146. The worm 141 is muff coupled to the driving shaft of the motor. The duplex worm wheels engage with the worm 141. The gear faces of the duplex worm wheels engage with the middle gear 143 which also engages with the gear wheel 145. The middle gear 143 is fixed on the bottom carriage 12 via a screw 147. The gear wheel 145 and the pinion 146 are fixed to the gear shaft 144. The top carriage 11 and the bottom carriage 12 are fixed to each other via fix screws 16.

The travel driving assembly 15 comprises a duplex gear 151, a traveling duplex gear 152 and a gear rack 153. The duplex gear 151 engages with the traveling duplex gear 152 which also engages with the gear rack 153. The pinion 146 also engages with the gear face of the outer diameter duplex gear 151.

The massage head assembly 2 comprises a pair of mushroom-like massage heads 21, 21′ at different heights, a massage assembly 22 and a massage head driving assembly 23 for the massage heads, which is fixed to the main body 1 via the gear shaft 144. The pair of mushroom-like massage heads 21, 21′ at different heights are mounted in the center bores 2211, 2212 formed on one side of a massage head support 221, respectively; the massage heads 21, 21′ can rotate freely. The massage assembly 22 comprises the massage head support 221 and a rotatable support 222. The massage heads 21, 21′ and the massage head support 221 are rotatably connected to the rotatable support 22 via a planet gear shaft 232. The driving assembly 23 comprises a planet gear 231, the planet gear shaft 232 which is fixed to the massage support 221, and a sun gear 233 which engages with the planet gear 231.

The massaging machine according to the present invention can have the following four types of movements by arranging the driving mechanism and the pair of massage heads and engagement between the gears and the gear racks:
i. Movement type one: the pair of massage heads 21, 21′ rotate freely when they are mounted in the center bore 2211 formed on one side of the massage head support 221.
ii. Movement type two: the massage head support 221 provided with the pair of massage heads 21, 21′ makes a circular motion around the planet gear shaft 232 fixed inside its center bore 2212 and passing through the center bore 2221 formed on the rotatable support 222 as the center of the circle.
iii. Movement type three: the rotatable support 222 provided with the massage head support 221 and the pair of massage heads 21, 21′ make a circular motion around the gear shaft 144 fixed to the sun gear 233 and the gear wheel 145 as the center of the circle.
iv. Movement type four: the carriage comprising the top carriage 11 and the bottom carriage 12 provided with the pair of massage heads 21, 21′ make a reciprocating motion along the gear rack 153.

Operation of the movements of the massage heads are described as follows:
i. The motor 13 drives the worm 141 to rotate. The worm 141 engages with the worm face of the duplex worm wheels 142, 142′ provided at two opposite sides of the worm 141. The gear face of the duplex worm wheels 142, 142′ engage with the middle gear 143, which in turn engages with the gear wheel 145. Therefore when the motor rotates, the gear wheel 145 will rotate accordingly.
ii. The gear wheel 145 is mounted on a respective position of bottom carriage 12 by the gear shaft 144. The pinion 146 and the rotatable support 222 are fixed on the gear shaft 144. When the gear wheel 145 rotates, the gear shaft 144 and the pinion 146 and the rotatable support 222 fixed on the pinion 146 will rotate accordingly (i.e., said movement type three). When the rotatable support 222 rotates, the sun gear 233 fixed below the rotatable support 222 will also rotate.
iii. When the sun gear 233 rotates, the planet gear 231 and the planet gear shaft 232 engaging with the sun gear 233 will also rotate. Because the planet gear shaft 232 is fixed to the massage head support 221, when the planet gear shaft 232 rotates, the massage head support 221 mounted with the pair of massage heads 21, 21′ at different heights also rotates (i.e., said movement type two).
iv. When the gear wheel 145 rotates, the gear shaft 144 and the pinion 146 fixed on it will also rotate. The pinion 146 engages with the tooth face of the duplex gear 151 with a greater outer diameter so that the traveling duplex gear 152 engaged with the tooth face of the duplex gear 151 having a small outer diameter will rotate when the pinion 146 rotates. The traveling duplex gear 152 also engages with the gear rack 153 so that the carriage assembly (assembled with the bottom carriage 11 and the top carriage 12) mounted with the massage heads 21, 21′ will reciprocate horizontally along the gear rack 153 (i.e., said movement type four).

Said movement type one is a kind of free motion. The controlling of said movement types two, three and four is described in Chinese utility model application number 200620139314.0 filed on Oct. 20, 2006 entitled “A Control System for a Reciprocating Object”, which is hereby incorporated by reference.

Although the invention has been described with reference to an exemplary embodiment, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed. Rather, the invention extends to all functionally equivalent structures, methods, and uses such as are within the scope of the appended claims.

1. A massaging machine comprising a motor, a main body and a massage head assembly, wherein
the main body comprises a top carriage, a bottom carriage, and a massage driving assembly and a traveling driving assembly provided between the top carriage and the bottom carriage; and
the massage head assembly comprises at least a massage head, a massage assembly and a massage head driving assembly fixed to the main body.

2. The massaging machine according to claim 1, wherein
the massage driving assembly comprises a worm fixed to the driving shaft of the motor, a duplex worm wheels engaged with the worm, a middle gear engaged with a gear face of the duplex worm wheels, a gear shaft, a gear wheel engaged with the middle gear, and a pinion fixed to the gear shaft with the gear wheel.

3. The massaging machine according to claim 1, wherein
the traveling driving assembly comprises a duplex gears, a traveling duplex gears engaged with the duplex gears and a gear rack engaged with the traveling duplex gears; and
the pinion engages with the gear face of the duplex gears having a larger outer diameter.

4. The massaging machine according to claim 1, wherein
the massage head driving assembly comprises a planet gear, a planet gear shaft fixed to a massage head support and mounted with the planet gear, and a sun gear engaged with the planet gear.

5. The massaging machine according to claim 1, wherein
the massage assembly comprises a massage head support and a rotatable support; and
the massage head and the massage head support are gear rotatably connected to the rotatable support via the planet gear shaft.

6. The massaging machine according to claim 1, wherein
the massage heads each have a mushroom-like shape and are mounted in pairs at different heights on the two sides of the massage head support each relative to a respective center bore on the massage head support.
